(19) United States
(12) Patent Application Publication
(10) Pub. No.: US 2018/0336482 A1
(43) Pub. Date: Nov. 22, 2018

(54) SOCIAL PREDICTION

(71) Applicants: Xiao-Feng YU, Beijing (CN); JunQing XIE, Beijing (CN); HEWLETT PACKARD ENTERPRISE DEVELOPMENT LP, Houston, TX (US)

(72) Inventors: Xiaofeng Yu, Beijing (CN); Jun Qing Xie, Beijing (CN)

(21) Appl. No.: 15/559,650

(22) PCT Filed: Apr. 13, 2015
(86) PCT No.: PCT/CN2015/076453

§ 371 Date: Sep. 19, 2017

(51) Int. Cl. G06N 5/04; G06N 99/00

(52) U.S. Cl. CPC G06N 5/048; G06N 99/005

(57) ABSTRACT

A device of performing social prediction in a social network may include a processor and a memory. In an example, instructions stored in the memory and executable by the processor may classify connections of user pairs within the social network into weak ties and strong ties according to tie strength of the connections. During the generation of a social network model, a first model may be set for the weak ties, and a second model may be set for the strong ties. The social network model may be trained to obtain model parameters, and social data of a user may be predicted by using the model parameters and the social network model.

### BACKGROUND

Generally, online social networks may be formed by nodes and connections, and the internet or other telecommunication networks formed by computers, servers, routers, switches, etc., may be used for running the online social networks. The nodes in a web-based social network may be users of the social network such as individuals or organizations, and the connections may be relationships, ties, or links between the nodes.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a block diagram illustrating the structure of a device for performing social prediction within a social network in accordance with an example of the present disclosure.

FIG. 2 is a block diagram illustrating the structure of a device for performing social prediction in accordance with an example of the present disclosure.

FIG. 3a is an illustrative example of social prediction including predicting social actions and labeling social ties.

FIG. 3b is a schematic diagram illustrating a weak tie aware social prediction (WTSP) model according to an example of the present disclosure.

FIG. 4 is a flowchart of learning model parameters for the WTSP model in accordance with an example of the present disclosure.

FIG. 5 is a flowchart illustrating a method of performing social prediction according to an example of the present disclosure.

FIG. 6 illustrates a procedure of obtaining a weak tie influence result according to an example of the present disclosure.

FIG. 7 illustrates a procedure of obtaining a strong tie influence result according to an example of the present disclosure.

FIG. 8 illustrates a procedure of training a social network model to obtain model parameters according to an example of the present disclosure.

FIG. 9 illustrates a procedure of predicting social data of a user according to an example of the present disclosure.

FIG. 10 illustrates a procedure of setting a first model for weak ties and setting a second model for strong ties to generate a social network model according to an example of the present disclosure.

FIG. 11 illustrates a procedure of setting a first model for weak ties and setting a second model for strong ties to generate a social network model according to an example of the present disclosure.

FIG. 12 illustrates a procedure of setting a first model for weak ties and setting a second model for strong ties to generate a social network model according to an example of the present disclosure.

FIG. 13 illustrates a non-transitory computer readable medium storing instructions executable by a processor according to an example of the present disclosure.

FIG. 14 illustrates an impact of weak ties for predicting social actions on a mobile dataset.

FIG. 15 illustrates an impact of weak ties for inferring social ties on a mobile dataset.

### DETAILED DESCRIPTION

Reference will now be made in detail to examples, which are illustrated in the accompanying drawings. In the following detailed description, numerous specific details are set forth in order to provide a thorough understanding of the present disclosure. Also, the figures are illustrations of an example, in which modules or procedures shown in the figures are not necessarily essential for implementing the present disclosure. In other instances, well-known methods, procedures, components, and circuits have not been described in detail so as not to unnecessarily obscure aspects of the examples.

Social prediction may involve social network analysis including operations to extract characteristics of network nodes, or to find out social relation or social interaction between two or more network nodes. In an example, the social prediction may include operations selected from the group including: predicting social actions, and labeling or discovering social ties. In an example, predicting the social actions may include prediction of users' characteristics, such as users' activities, behaviors, etc., and labeling the social ties may include determination of attributes of user-user connections. The user-user connection may refer to a connection between a pair of users connected. In an example, a device of performing social prediction is provided in the present disclosure. The device may utilize weak ties of the social network together with strong ties during the social prediction in order to discover users' characteristics for social action prediction and infer attributes of user-user connections for social tie labeling. Examples of the users' characteristics may include activities, behaviors, opinions, emotions, or interests of the users. The social actions may be the users' characteristics in connected social networks. For example, a social action can be “posting a tweet” or a “check-in” behavior on the World Wide Web. In another example, the social action may be the status of a user, such as idle, busy, active, etc. The social ties may be the attributes of the user-user connections. Examples of the attributes of the user-user connections may include social relation between two connected users in a social network. In an example, the social relation may include such as friend, family, frenemy, and colleague relationships. Weak ties may refer to contacts of a user with less interaction, while strong ties may refer to contacts the user communicates with frequently. In an example, a threshold may be set for classifying tie strength of a connection between a user pair. Accordingly, a user-user connection having the tie strength under the threshold may be determined as a weak tie, and the user-user connection having the tie strength above the threshold may be considered as a strong tie. As used herein, the tie strength may refer to the degree of intensity of a user-user connection, and the user pair may refer to a pair of users having a user-user connection. In an example, a user pair having a strong tie may be close friends.

In an example, both the weak ties and the strong ties are used for generalized social prediction in a single coherent framework. The strong ties may heavily affect emotion of users, and the users having the strong ties may often join together to form dense clusters or organizations, thereby causing the phenomenon of homophily. Homophily may refer to the tendency of users to associate and bond with similar others. Users in homophilic relationships share common characteristics (such as beliefs, values, education, etc.) that make communication and relationship formation easier. For example, users share information on social media sites with their close friends who share the same ambitions and goals. Also, due to the diversity of information spreading and the variance of link information, current popular and predominant online social networks often include weak ties, which reach far across networks with infrequent communications. The weak ties (e.g., loose acquaintances) are crucial in expediting the transfer of knowledge across dense clusters characterized by the strong ties. The strength of weak ties is implied in the heterophily phenomenon. For example, compared to strong ties, users are more likely to obtain information about job openings and opportunities from weak ties. In an example, heterophily is the opposite of homophily, and provides variety for users.

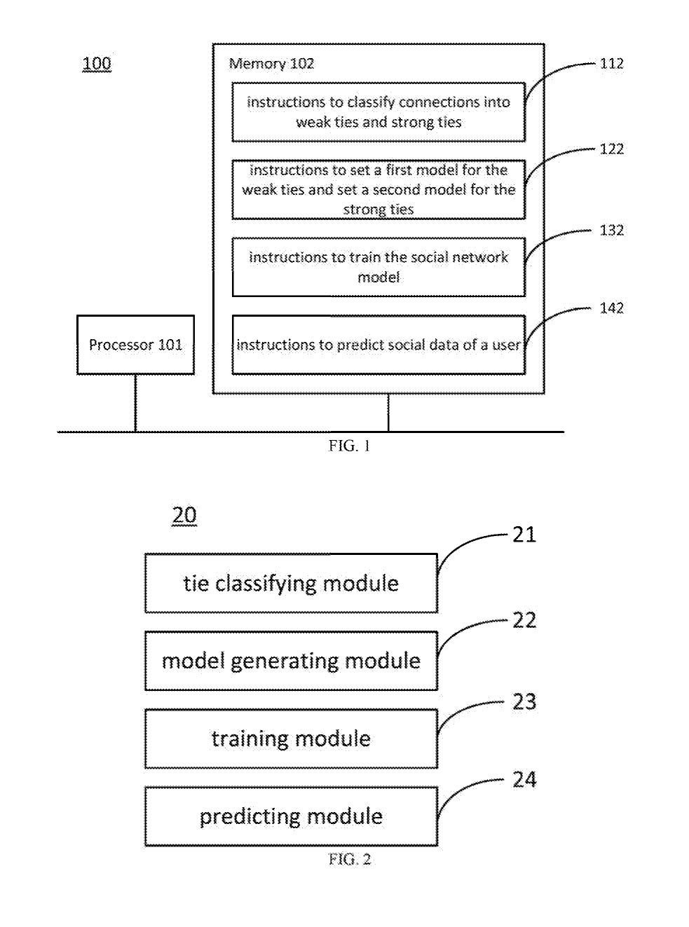

FIG. 1 shows the structure of a device 100 for performing social prediction within a social network. In an example, the device 100 may include a processor 101 and a memory 102. The memory 102 may be non-transitory machine-readable medium that may store instructions executable by the processor 101. In an example, the instructions may include: instructions to classify connections of user pairs within the social network into weak ties and strong ties 112; instructions to set a first model for the weak ties and set a second model for the strong ties to generate a social network model 122; instructions to train the social network model to obtain model parameters 132; and instructions to predict social data of a user by using the model parameters and the social network model 142. In one implementation, the instructions stored in the memory 102 may implement the techniques described in FIGS. 2-13.

In an example, the first model may refer to an impact of weak ties during the social prediction. In an example, the first model may be calculated by multiplying first functions, first model parameters, and a weighting factor for the weak ties, wherein the first functions may be properties of social prediction features related to the weak ties. The social prediction features may be selected from the group including social actions and social ties. Examples of the first model may include a first tie model

$$α {\sum }_{k ∈ WT ( {u}_{i} , {u}_{j} )} {λ}_{k} {g}_{k} ( {u}_{i} , {u}_{j} , {x}_{ij} )$$

in Formula (4), and/or a first action model

$$β {\sum }_{r ∈ WT ( {u}_{i} )}^{ } {θ}_{r} {h}_{r} ( {u}_{i} , {m}_{ij} )$$

in Formula (6). In an example, the weighting factor for the weak ties may refer to α, the first model parameters may refer to λₖ, and the first functions may refer to gₖ(uᵢ,uⱼ,xᵢⱼ). In another example, the weighting factor for the weak ties may refer to β, the first model parameters may refer to θᵣ, and the first functions may refer to hᵣ(uⱼ,mᵢⱼ). In an example, the second model may refer to an impact of strong ties during the social prediction. In an example, the second model may be calculated by multiplying second functions, second model parameters, and a weighting factor for the strong ties, wherein the second functions may be properties of the social prediction features related to the strong ties. Examples of the second model may include a second tie model

$$( 1 - α ) {\sum }_{l ∈ ST ( {u}_{i} , {u}_{j} )} {λ}_{l} {f}_{l} ( {u}_{i} , {u}_{j} , {z}_{ij} )$$

in Formula (4), and/or a second action model

$$( 1 - β ) {\sum }_{v ∈ ST ( {u}_{i} )} {θ}_{v} {q}_{v} ( {u}_{i} , {w}_{ij} )$$

in Formula (6). In an example, the weighting factor for the strong ties may refer to (1−α), the second model parameters may refer to λₜ, and the second functions may refer to ƒᵢ(uᵢ,uⱼ,zᵢⱼ). In another example, the weighting factor for the strong ties may refer to (1−β), the second model parameters may refer to θᵥ, and the second functions may refer to qᵥ(uᵢ,wᵢⱼ). The social network model may refer to a model for expressing the social prediction tasks such as social action prediction and social tie labeling. Examples of the social network model may be illustrated in such as Formulas (8), (23), (25), and (31). The model parameters may be a set of parameters for defining the social network model. The social data may refer to a class of social action of a user, and/or a class of social tie of a user pair. In an example, the class may be a type of the social action, such as idle, busy, and active; or the class may be a label of the social tie, such as family, friend, and acquaintance.

FIG. 2 is a block diagram illustrating the structure of a device 20 for performing social prediction in accordance with an example of the present disclosure. In an example, the instructions 112 may be implemented via a tie classifying module 21. That is, the tie classifying module 21 may be set for implementing functions of the instructions 112. Similarly, the instructions 122 may be implemented via a model generating module 22, the instructions 132 may be implemented via a training module 23, and the instructions 142 may be implemented via a predicting module 24.

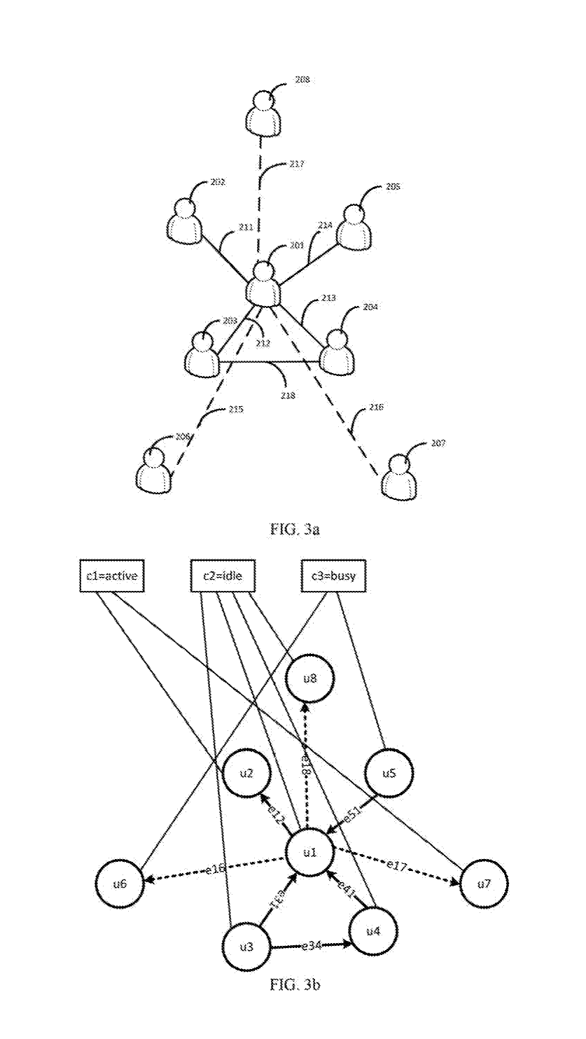

Each of the modules may include, for example, at least one hardware device including electronic circuitry for implementing the functionality described in FIG. 1, such as control logic and/or memory. In addition or as an alternative, the modules may be implemented as any combination of hardware and software to implement the functionalities of the modules. For example, the hardware may be a processor and the software may be a series of instructions or microcode encoded on a machine-readable storage medium and executable by the processor. Therefore, as used herein, a module may include program code, e.g., computer executable instructions, hardware, firmware, and/or logic, or combination thereof to perform particular actions, tasks, and functions described in more detail herein in reference to FIGS. 3-13.

In an example, the device 100 as shown in FIG. 1 can be used to track users' behaviors, infer labels of social ties, and model users' interests for recommendation. The device 100 may be a server for operating the social network, a computing device for providing access to the social network for a user, or an application installed in a user terminal. In an implementation where the device 100 may be a server for operating a social network, social prediction may enhance the attractiveness of the social network to users, thereby boosting the revenue of social network services. As to the computing device for accessing the social network, such as a mobile terminal, a smart electronic device, a camera, etc., social prediction may help the user of the computing device acquire useful information within the social network.

In an example, the social network may be expressed by Formula (1). That is, by use of information of users and information of user-user connections, social actions of the users and social ties of user pairs may be deducted.

MD:G=(U,E)→{y,s} (1)

In Formula (1), MD refers to a social prediction model, G refers to a social network, wherein G=(U,E) represents that there are N users, and M connections or dyads really existed among the N users in the social network G. Specifically, U={uᵢ}ᵢ₌₁^{N}(uᵢ∈U), and E={eᵢⱼ}_{i,j}^{M}(eᵢⱼ∈E). In Formula (1), y represents the social actions of the N users, and s is social ties of the M connections among the N users. Specifically, y={yᵢ}ᵢ₌₁^{N} (yᵢ ∈y), wherein yᵢ is characteristics of a user, such as the user's statuses, behaviors, opinions, emotions, interests, etc. In an example, the social action yᵢ may have three classes, i.e., idle, busy, and active, respectively, representing different statuses of users. Specifically, s{sᵢⱼ}_{i,j}^{M}(sᵢⱼ∈s), wherein sᵢⱼ is a relationship between a pair of users (uᵢ,uⱼ) in the social network G. That is, s is formed by a set of sᵢⱼ, and sᵢⱼ is an element of the set s. In reality, user-user connections in a social media are much richer, and relationships between users can be either directed or undirected. Therefore, the social prediction task may not been limited to binary social tie labeling, e.g., positive and negative labeling. In an example, the social tie sᵢⱼ may have four classes, i.e., family, friend, acquaintance, and colleague. During the social prediction, a unified model MD may be obtained to enable that y and s are optimized.

FIG. 3a is an illustrative example of the result of social prediction in the present disclosure. In the example, the social actions may include statuses of users, e.g., idle, active and busy, and the social ties may include relationships among users, e.g., friend, family and acquaintance. In FIG. 3a, there are 8 users, and 8 user pairs in the social network. That is, N=8 and M=8. The 8 users may include users 201, 202, 203, 204, 205, 206, 207, 208. Among the eight users, the social actions of the users may be idle, active, idle, idle, busy, busy, active, and idle, respectively. According to Formula (1), the social actions illustrated in FIG. 3a may be expressed as y={y₁,y₂,y₃,y₄,y₅,y₆,y₇,y₈}={idle,active,idle,idle,busy,busy,active,idle}. In an example, user 201 and user 202 shown in FIG. 3a may form a user pair. The 8 connections may include connections 211-218. Among the 8 connections, social ties of the connections may be friend, family, family, friend, acquaintance, acquaintance, acquaintance, and family, respectively. According to Formula (1), the social ties illustrated in FIG. 3a may be expressed as s={s₁₂,s₁₃,s₁₄,s₁₅,s₁₆,s₁₇,s₁₈,s₃₄}={friend,family,family,friend,acquaintance,acquaintance,acquaintance,family}. Different from the coarse representation of relationship nature in the binary relation tie labeling, there are three classes of social ties in FIG. 3a, which may be scalable to more classes based on real-world applications.

In FIG. 3a, user 201 has four strong tie contacts 202-205 (shown in solid lines), and three weak tie contacts 206-208 (shown in dashed lines). In an example, strong ties and weak ties may be classified by a contact frequency of user pairs. In one implementation, a threshold for differentiating strong ties and weak ties may be a contact frequency of 6 times a month. When a user pair has the contact frequency of 10 times a month, the user pair may have a strong tie. When a user pair has the contact frequency of 2 times a month, the user pair may have a weak tie. Usually, if the social tie of a connection is friend or family, the corresponding user pair may have a strong tie. In an example, since the social ties of connections 211-214 are friend, family, family, friend, respectively, these user pairs may have a strong tie. In another example, since the social ties of connections 215-217 are acquaintances, these user pairs may have a weak tie.

The social network of FIG. 3a may be illustrated in another form in FIG. 3b. Specifically, FIG. 3b is a graphical representation of a WTSP model in accordance with an example of the present disclosure. In FIG. 3b, there are 8 users (u1-u8), 8 connections, 5 strong ties (in solid lines), and 3 weak ties (in dashed lines). The 8 users have 3 social action classes, which are active, idle, and busy, respectively. The 8 connections are e12, e16, e17, e18, e31, e41, e51, e34, respectively.

In an example, a social action yᵢ may be associated with each user uᵢ ∈U, and a social tie sᵢⱼ may be used as a relationship label assigned with a connection eᵢⱼ∈E between users uᵢ and uⱼ in the social network G. Instead of performing single prediction task, mutual bidirectional interactions and deep dependencies between social actions y and social ties s are modeled in an example of the present disclosure, which are consistent with the real-world scenarios and may likely raise the degree of accuracy in performance. In an example, Bayesian rule may be applied for the calculation of a joint probability distribution P(y,s|G) of the social actions y and the social ties s. That is, P(y,s|G) equals to P(s|G)P(y|s,G). Accordingly, P(y,s|G) can be decomposed as Formula (2).

$$P ( y , s \vert G ) = P ( s \vert G ) P ( y \vert s , G ) = {\prod }_{{e}_{ij} ∈ E} P ( {s}_{ij} \vert G ) {\prod }_{{u}_{i} ∈ U} P ( {y}_{i} \vert {s}_{ij} , G ) = {{\prod }_{i , j}}^{M} P ( {s}_{ij} \vert G ) {\prod }_{i = 1}^{N} P ( {y}_{i} \vert {s}_{ij} , G ) \qquad ( 2 )$$

In Formula (2), P(s|G) represents a probability distribution of the social ties s conditioned on the social network G, P(y|s,G) represents a probability distribution of the social actions y given the social ties s and the social network G. N is the number of users, and M is the number of connections among the N users. In an example, uᵢ represents the user, and eᵢⱼ represents the user-user connection. It can be seen that the modeling in Formula (2) considers the joint probability distribution of the social actions y and the social ties s, and provides a mutual prediction to integrate a variety of distributions.

In an example, the relationship between the joint probability distribution P(y,s|G) and a set of model parameters of the joint probability distribution may be found gradually via the deduction of Formulas (3)-(8). Thereafter, the model parameters may be determined via a learning procedure, in order to determine the joint probability distribution of the social actions y and the social ties s. The learning procedure may be a machine learning operated by building a model based on inputs and using the model to make predictions or decisions, rather than following only explicitly programmed instructions.

In an example, the learning procedure may be implemented based on Formulas (9)-(15). The class of the social action yᵢ and the class of the social tie sᵢⱼ of a user may be calculated according to Formula (16). Eventually, most likely types of social actions y* and corresponding labels of social ties s* may be determined according to Formula (17).

In an example, in order to learn the characteristics or features of users and user-user connections for social prediction, a Gaussian distribution may be employed to model conditional probabilities P(s|G) and P(y|s,G) illustrated in Formula (2). In an example, other appropriate distributions, such as Factor Graph, may be adopted for calculating the conditional probabilities P(s|G) and P(y|s,G).

In an example, to specify P(s|G) for modeling the social ties s, it is assumed that both weak ties and strong ties of a user pair (uᵢ,uⱼ) have contribution to the social ties. In an example, the probability distribution of P(s|G) may be defined in Formulas (3) and (4).

$$\begin{matrix}P ( {s}_{ij} \vert G ) ∝ K ( {s}_{ij} \vert {μ}_{s} , {σ}_{s}^{2} I ) & ( 3 ) \\ {μ}_{s} = α {\sum }_{k ∈ WT ( {u}_{i} , {u}_{j} )} {λ}_{k} {g}_{k} ( {u}_{i} , {u}_{j} , {x}_{ij} ) + ( 1 - α ) {\sum }_{l ∈ ST ( {u}_{i} , {u}_{j} )} {λ}_{l} {f}_{l} ( {u}_{i} , {u}_{j} , {z}_{ij} ) & ( 4 )\end{matrix}$$

In Formula (3), a probability density function K(x|μ,σ₂I) is used, wherein P is the mean, and σ²I is the variance. In probability theory, the probability density function may be a function that describes the relative likelihood for a random variable to take on a given value. In an example, K(x|μ,σ²I) equals to

$$exp \{ - \frac{1}{2 {σ}^{2}} {( μ - x )}^{2} \} ,$$

wherein exp{ } refers to an exponential function. Specifically, σₛ² is the variance for the social ties in the Gaussian distribution.

In Formula (4), WT(uᵢ,uⱼ) represents a weak tie set of a user pair (uᵢ, uⱼ), and k is an index in the weak tie set for the user pair (uᵢ,uⱼ). In Formula (4), ST(uᵢ,uⱼ) represents a strong tie set of the user pair (uᵢ,uⱼ), and l is an index in the strong tie set for the user pair (uᵢ,uⱼ). During the social prediction, a first tie factor α is introduced to weight the probability or degree of the influence and contribution of the weak ties on social tie labeling. In an example, 0≤α≤1. Accordingly, a second tie factor 1−α is the degree of the contribution of the strong ties on social tie labeling. That way, both the strength of the weak ties and the strong ties are incorporated into social tie labeling. In an example, g(uᵢ,uⱼ) represents a first tie function for capturing characteristics or features of the weak tie set, and ƒ(uᵢ,uⱼ) represents a second tie function capturing characteristics or features of the strong tie set. In an example, g(uᵢ,uⱼ) may be the frequency of calls within a month between uᵢ and uⱼ. The value of gₖ may be 0 or 1, wherein 1 represents high frequency while 0 represents low frequency. A weight vector λ_{g} may be expressed as (λ₁, . . . , λₖ), and λ_{f} may be expressed as (λₜ, . . . , λₜ). In an example, λ_{g} is a real-valued weight vector associated with the first tie function g(uᵢ,uⱼ), and λ_{f} is a real-valued weight vector associated with the second tie function ƒ(uᵢ,uⱼ).

With continued reference to Formulas (3) and (4), in order to increase the accuracy of social prediction, a set of auxiliary, hidden, or latent attributes or properties may be introduced to capture the interactions from social actions on social tie labeling. Although such interactions are implicit and unobservable in real-world social networks, they may play an importance role for social prediction. In an example, these latent attributes may be differentiated between the weak ties and the strong ties. In an example, a first latent attribute xᵢⱼ represents a set of hidden properties of the social ties influenced by the social actions on the weak tie set, and a second latent attribute zᵢⱼ represents a set of hidden properties of the social ties influenced by the social actions on the strong tie set. Accordingly, g(uᵢ,uⱼ) may also be represented as g(uᵢ,uⱼ,xᵢⱼ), and ƒ(uᵢ,uⱼ) may also be represented as ƒ(uᵢ,uⱼ,zᵢⱼ). As such, observable characteristics and unobservable hidden properties may both be taken into consideration for social prediction.

In an example, to specify P(y|s,G) for modeling the social actions y, a first action factor is introduced to weight the degree of contribution of the weak ties on social action prediction, and a second action factor is introduced to weight the degree of contribution of the strong ties on the social action prediction. In an example, the first action factor is β, and the second action factor is 1−β, wherein 0≤β≤1. For characterizing the social actions y of the user uᵢ, WT(uᵢ) represents a weak tie set of the user uᵢ, and ST(uᵢ) represents a strong tie set of the user uᵢ. In an example, r is an index in the weak tie set for the user uᵢ, and v is an index in the strong tie set for the user uᵢ. Accordingly, h(uᵢ,mᵢⱼ) represents a first action function for capturing characteristics or features of the weak tie set of uₜ, and q(uᵢ,wᵢⱼ) represents a second action function for capturing characteristics or features of the strong tie set of uᵢ. In an example, h(uᵢ,mᵢⱼ) may be the first action function for determining whether another user having a weak tie with uᵢ has the same social action as uᵢ. The value of hᵣ may be 0 or 1, wherein 1 represents that the social actions of the two users are the same, while 0 represents different social actions. Referring to FIG. 3a, yᵢ and yₛ have the same social action, while y₁ and y₆ have different social actions. θₕ is a real-valued weight vector for the function h(uᵢ,mᵢⱼ), and θ_{q} is a real-valued weight vector for the function q(uᵢ,wᵢⱼ). In an example, θₕ may be expressed as (θ₁, . . . , θᵣ), and θ_{q} may be expressed as (θ₁, . . . , θₕ). In an example, mᵢⱼ is a latent attribute for the weak tie set, and wᵢⱼ is a latent attribute for the strong tie set. Both mᵢⱼ and wᵢⱼ may be used to explore the influences from the social ties on social action prediction. In an example, the probability distribution of P(y|s,G) may be defined as Formulas (5) and (6). In Formula (5) σ_{y}²I is the variance for social action in the Gaussian distribution.

$$\begin{matrix}P ( {y}_{i} \vert {s}_{ij} , G ) ∝ K ( {y}_{i} \vert {μ}_{y} , {σ}_{y}^{2} I ) & ( 5 ) \\ {μ}_{y} = β {\sum }_{r ∈ WT ( {u}_{i} )} {θ}_{r} {h}_{r} ( {u}_{i} , {m}_{ij} ) + ( 1 - β ) {\sum }_{v ∈ ST ( {u}_{i} )} {θ}_{v} {q}_{v} ( {u}_{i} , {w}_{ij} ) & ( 6 )\end{matrix}$$

By applying Formulas (2)-(6), the joint probability distribution P(y,s|G) may be specified as Formula (7).

$$P ( y , s \vert G ) ∝ ( {\prod }_{i , j}^{M} K ( {s}_{ij} \vert {μ}_{s} , {σ}_{s}^{2} I ) ) \times ( {\prod }_{i = 1}^{N} K ( {y}_{i} \vert {μ}_{y} , {σ}_{y}^{2} I ) ) \qquad ( 7 )$$

The social prediction provided in Formula (7) may have the following characteristics. By introducing the first tie factor α and the first action factor β, a WTSP model may exploit both weak ties and strong ties for social prediction. That is, the strength of weak ties is captured in the modeling, without adding difficulty to parameter estimation and inference procedures. Moreover, the WTSP model may capture bidirectional dependencies and mutual influence between social actions and social ties by calculating the joint probability distribution of the social actions y and the social ties s, and further by the incorporation of auxiliary latent attributes.

In an example, the functions g(uᵢ,uⱼ,xᵢⱼ), ƒ(uᵢ,uⱼ,zᵢⱼ), h(uᵢ,mᵢⱼ), q(uᵢ,wᵢⱼ) in Formulas (4) and (6) are expressed in the vector form of g, f, b, q, respectively. Then, P(y,s|G) may be denoted as Formula (8). In other words, the WTSP model may be defined according to Formula (8).

$$P ( y , s \vert G ) ∝ ( {\prod }_{i , j}^{M} exp \{ - \frac{1}{2 {σ}_{s}^{2}} {( α {λ}_{g}^{T} g + ( 1 - α ) {λ}_{r}^{T} f - {s}_{ij} )}^{2} \} ) \times ( {\prod }_{i = 1}^{N} exp \{ - \frac{1}{2 {σ}_{y}^{2}} {( β {θ}_{h}^{T} h + ( 1 - β ) {θ}_{q}^{T} q - {y}_{i} )}^{2} \} ) \qquad ( 8 )$$

In an example, in order to optimize P(y,s|G), the set of model parameters W={λ_{g},λ_{f},θₕ,θ_{q}} of P(y,s|G), that can maximize the log-likelihood of input data D of the social network, may be found. The input data D may be social data for users predetermined or already known. Such kind of data D can be used for learning and optimizing model parameters of the social network model. Taking the logarithm of Formula (8), the log-likelihood of the input data D may be determined. For many applications, the natural logarithm of a likelihood function, called the log-likelihood, is more convenient to work with. Formula (9) uses the Lagrange method to calculate the model parameters of the WTSP model defined in Formula (8). Maximizing the log-posterior is equivalent to minimizing the following sum-of-squared-errors objective function with quadratic regularization terms as Formula (9).

$$L ( D , {λ}_{g} , {λ}_{f} , {θ}_{h} , {θ}_{q} ) = \frac{1}{2} {\prod }_{i , j}^{M} {( α {λ}_{g}^{T} g + ( 1 - α ) {λ}_{f}^{T} f - {s}_{ij} )}^{2} + \frac{1}{2} {\prod }_{i = 1}^{N} {( β {θ}_{h}^{T} h + ( 1 - β ) {θ}_{q}^{T} q - {y}_{i} )}^{2} + \frac{{d}_{s}}{2} {‖ {λ}_{g} ‖}_{F}^{2} + \frac{{d}_{f}}{2} {‖ {λ}_{f} ‖}_{F}^{2} + \frac{{d}_{h}}{2} {‖ {θ}_{h} ‖}_{F}^{2} + \frac{{d}_{q}}{2} {‖ {θ}_{q} ‖}_{F}^{2} \qquad ( 9 )$$

In Formula (9), L is the sum-of-squared-errors objective function, serving as the loss function for estimation of model parameters of the WTSP model, dₛ, d_{f}, dₕ, d_{q} are regularization parameters. In Formula (9), ∥•∥_{F}² denotes the Frobenius norm. In one example, this negative log-likelihood serves as the loss function for WTSP parameter estimation. To help combat over-fitting, L2 regularization methods may be used on the model parameters λ_{g}, λ_{f}, θₕ, θ_{q}, which can be regarded as Gaussian priors. For example, as to λ_{g},

$$P ( {λ}_{g} ) ∝ {e}^{- \frac{{d}_{s}}{2} {λ}_{g}^{T} {λ}_{g}} .$$

Similar methods may be applied on λ_{f}, θₕ, and θ_{q}.

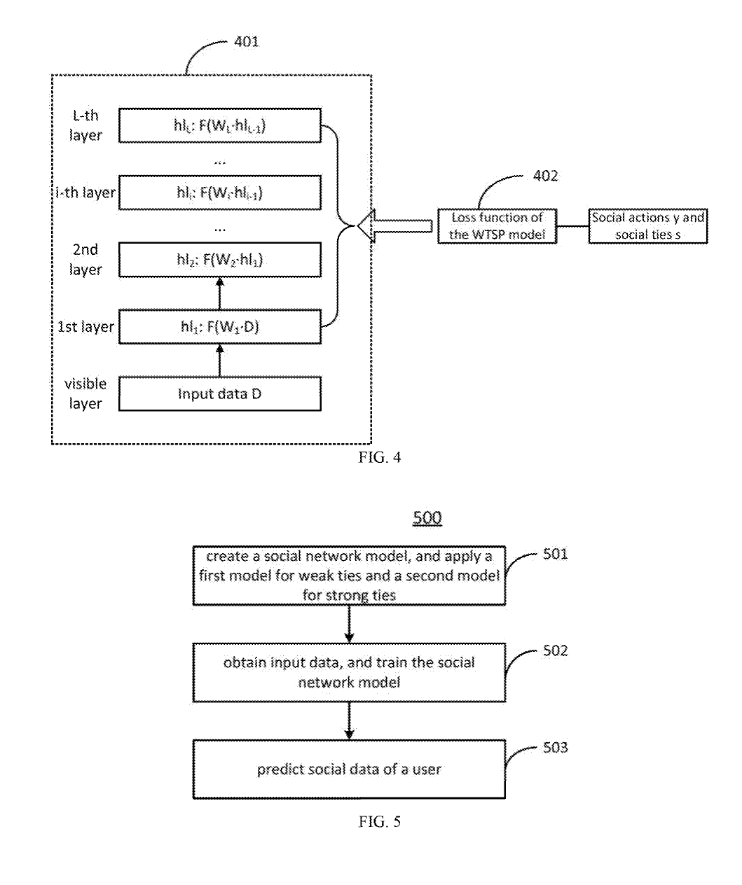

In an example, the WTSP model may be considered as a deep neural network. The deep neural network may refer to a neural network that has two or more layers of hidden processing neurons, and may be used in machine learning research. The deep neural network is a more computationally powerful cousin to regular neural networks. Accordingly, a deep learning architecture for the WTSP model may include L hidden layers and a visible layer, which are shown in FIG. 4. A hidden layer may represent intermediate data that are not available in the beginning and are gradually attainable via calculation. In an example, the number of hidden layers is L, wherein L is an integer. A visible layer may represent social data already known. The deep learning architecture can scale better with the input data D of the social network, and automatically learn discriminative features. The deep learning architecture may process the input data D through a sequence of non-linear transformations. More specifically, at an i-th hidden layer, the social network may compute as Formula (10). In other words, the input data D may be considered as social data of the visible layer, and social data of the i-th hidden layer is calculated based on Formula (10).

hIᵢ=F(WᵢhIᵢ₋₁+bᵢ) (10)

In Formula (10), Wᵢ is the model parameter vector of the WTSP model in the i-th layer, b₁ is a bias vector, and hIᵢ is social data of the i-th hidden layer, wherein i>0. If i=0, the i-th layer is a visible layer representing the input data D. There are many choices for the point-wise non-linearity function F used in Formula (10). In an example, a logistic function F(x)=1/(1+exp(−x)) may be adopted as F in Formula (10).

In an example, training the model parameters of the social network model may be performed by minimizing the loss function defined in Formula (9). In an example, a stochastic gradient descent (SGD) method may be adopted to train the model parameters, due to the ease of implementation and its tendency to converge to better optima in comparison with other training methods. The model parameters may be estimated in a mutual and collaborative manner. Once λ_{g} and λ_{f} for the social ties have been updated, they can aid the learning of parameters θₕ and θ_{q} for the social actions. On the other hand, the update of parameters θₕ and θ_{q} may be of help to the learning of parameters λ_{g} and λ_{f}. The training procedure illustrated in FIG. 4 may not only allow learning of social action parameters to capture social tie influence, but also optimizing social tie parameters to alleviate social action influence. The training procedure may run iteratively until converge to boost both the optimization of the social actions and the social ties.

In an example, Wₗ^{f} is the parameter vector in the i-th layer in the deep learning architecture after t−1 weight updates. In the SGD method, the parameter vector may be updated using Formula (11).

Wᵢⁱ⁺¹=Wᵢ^{j}−η∂T/Wᵢ^{j} (11)

In Formula (11), η is the learning rate, t is the iteration number in the deep learning procedure. For example, when t is the current iteration number, t+1 is the next one. In an example, a fixed learning rate may be used for the parameters λ_{g}, λ_{f}, θₕ and θ_{q}, since the fixed learning rate yields good performance in real experiments.

When i=1, T may equal to the loss function L defined in Formula (9), derivatives are taken with respect to the parameters λ_{g}, λ^{f}, θₕ and θ_{q} as Formulas (12)-(15). When i=2, . . . , L, T may equal to hIᵢ₋₁ defined in Formula (10).

$$\begin{matrix}\frac{\partial L}{\partial {λ}_{g}} = α {\prod }_{i , j}^{M} ( α {λ}_{g}^{T} g + ( 1 - α ) {λ}_{f}^{T} f - {s}_{ij} ) g + {d}_{g} {λ}_{g} & ( 12 ) \\ \frac{\partial L}{\partial {λ}_{r}} = ( 1 - α ) {\prod }_{i , j}^{M} ( α {λ}_{g}^{T} g + ( 1 - α ) {λ}_{f}^{T} f - {s}_{ij} ) f + {d}_{f} {λ}_{f} & ( 13 ) \\ \frac{\partial L}{\partial {θ}_{h}} = β {\prod }_{i = 1}^{N} ( β {θ}_{h}^{T} h + ( 1 - β ) {θ}_{q}^{T} q - {y}_{i} ) h + {d}_{h} {θ}_{h} & ( 14 ) \\ \frac{\partial L}{\partial {θ}_{q}} = ( 1 - β ) {\prod }_{i = 1}^{N} ( β {θ}_{h}^{T} h + ( 1 - β ) {θ}_{q}^{T} q - {y}_{i} ) q + {d}_{q} {θ}_{q} & ( 15 )\end{matrix}$$

Specifically, at a first layer, according to W₁^{t+1}=W₁^{f}−η∂L/W₁ⁱ of Formula (11), W₁ may be calculated. Afterwards, hI₁ may be calculated based on hI₁=F(WᵢD+bᵢ) of Formula (10). The calculated hI₁ may in turn used for calculating W₂ of a second layer in accordance with W₂^{t+1}=W₂^{f}−η∂L/W₂ⁱ. Then, hᵢ may be calculated according to hI₂=F(W₂hI₁+b₂). That is, Formulas (10)-(15) may provide a way to acquire the model parameters W through deep learning. After an optimized parameter vector W={λ_{g},λ_{f}, θₕ,θ_{q}} is obtained via the deep learning architecture, the model parameters W can be used to predict social actions and label social ties for a specific network scenario. The topmost layer of the social network (i.e., the L-th layer) uses a softmax non-linearity to predict probability values for both social actions and social ties. The probability prediction of the o-th class (including classes of both social actions and social ties) is defined in Formula (16). In other words, the social prediction is to determine a class of a social prediction feature, which is unknown to a user, according to the probability calculated according to Formula (16).

$$P ( o \vert D ) = \frac{exp ( {( {W}_{L} )}^{o} {hl}_{L - 1} + {b}_{L}^{o} )}{{\sum }_{i = 1}^{C} exp ( {( {W}_{L} )}^{i} {hl}_{L} + {b}_{L}^{i} )} \qquad ( 16 )$$

In Formula (16), C is the total number of classes of either the social actions or the social ties. The classes of social actions or social ties may be predicted by finding the maximum a posterior (MAP) social action labeling assignment and corresponding social tie labeling assignment that have the largest probability prediction. In Formula (16), L is the L-th hidden layer in the deep learning architecture. (W_{L})^{o} is the parameter vector of the L-th hidden layer for the o-th class, and (W_{L})ⁱ is the parameter vector of the L-th hidden layer for the i-th class, wherein i=1, . . . , C.

In an example, the social prediction may be done by finding the most likely classes of social actions y* and corresponding classes of social ties s* that have the maximum a posterior (MAP) probability according to Formula (17) such that both of them are optimized. In other words, P(y*,s*|G) has the MAP probability.

$$( {y}^{*} , {s}^{*} ) = {arg max}_{( y , s )} P ( y , s \vert G ) \qquad ( 17 )$$

It can be seen that FIG. 4 shows the procedure of determining the most likely classes of social actions y* and the most likely classes of social ties s* according to Formulas (9)-(17). Specifically, Formula (10) illustrates the process of achieving hI₁ from the input data D, achieving hI₂ from hI₁, and achieving hIᵢ from hIᵢ₋₁, and gradually achieving hI_{L} from hI_{L-1}, as shown in block 401 of FIG. 4. The loss function L of the WTSP model 402 illustrated in Formula (9) may be applied to calculate the model parameters W based on Formulas (11)-(15), and the model parameters W calculated may be used to deduce hI_{L-1} and hI_{L}. Eventually, y* and s* may be figured out by use of Formulas (16) and (17).

In an example of the present disclosure, not only homophily is exploited to capture the power of strong ties for social prediction, but also heterophily is considered to illustrate the strength of weak ties, which are important in promoting information flow in socially connected networks. In an example, homophily is the tendency of individuals to associate and bond with similar others, while heterophily is the tendency of individuals to collect in diverse groups.

In an example, another formulation of the WTSP model may be provided. By applying Bayesian rule, a joint probability distribution P(y,s|G) can be decomposed as Formula (18).

$$P ( y , s \vert G ) = P ( y \vert G ) P ( s \vert y , G ) = {\prod }_{{u}_{i} ∈ U}^{ } P ( {y}_{i} \vert G ) {\prod }_{{e}_{ij} ∈ E}^{ } P ( {s}_{ij} \vert {y}_{i} , G ) = {\prod }_{i = 1}^{N} P ( {y}_{i} \vert G ) {\prod }_{i , j}^{M} P ( {s}_{ij} \vert {y}_{i} , G ) \qquad ( 18 )$$

The distribution of P(y|G) in Formula (18) can be defined as Formulas (19)-(20).

$$\begin{matrix}P ( {y}_{i} \vert G ) ∝ K ( {y}_{i} \vert {μ}_{y}^{′} , {σ}_{y}^{2} I ) & ( 19 ) \\ {μ}_{y}^{′} = β {\sum }_{r ∈ WT ( {u}_{i} )} {θ}_{r} {h}_{r} ( {u}_{i} , {x}_{ij}^{′} ) + ( 1 - β ) {\sum }_{v ∈ ST ( {u}_{i} )} {θ}_{v} {q}_{v} ( {u}_{i} , {z}_{ij}^{′} ) & ( 20 )\end{matrix}$$

In Formula (20), xᵢⱼ* and zᵢⱼ* are introduced sets of auxiliary hidden, or latent attributes or properties to capture the interactions from social ties on social action prediction. Specifically, xᵢⱼ* is a latent attribute on the weak tie set, and zᵢⱼ* is a latent attribute on the strong tie set. Apart from xᵢⱼ* and zᵢⱼ*, other notations in Formula (20) are the same as those used in Formula (6).

In an example, the probability distribution of P(s|y,G) in Formula (18) may be defined as Formulas (21) and (22).

$$\begin{matrix} P ( {s}_{ij} \vert {y}_{i} , G ) ∝ K ( {s}_{ij} \vert {μ}_{s}^{′} , {σ}_{s}^{2} I ) & ( 21 ) \\ {μ}_{s}^{′} = α {\sum }_{k ∈ WT ( {u}_{i} , {u}_{j} )} {λ}_{k} {g}_{k} ( {u}_{i} , {u}_{j} , {m}_{ij}^{′} ) + ( 1 - α ) {\sum }_{l ∈ ST ( {u}_{i} , {u}_{j} )} {λ}_{l} {f}_{l} ( {u}_{i} , {u}_{j} , {w}_{ij}^{′} ) & ( 22 )\end{matrix}$$

In Formula (22), mᵢⱼ* and wᵢⱼ* are introduced auxiliary latent attributes for weak ties and strong ties to explore the influences from social actions on social tie prediction. Apart from mᵢⱼ* and wᵢⱼ*, other notations in Formula (22) are the same as those cited in Formula (4).

By applying Formulas (18)-(22), the joint probability distribution P(y,s|G) can be specified as Formula (23). In other words, another WTSP model may be defined in Formula (23).

$$P ( y , s \vert G ) = {\prod }_{i = 1}^{N} P ( {y}_{i} \vert G ) {\prod }_{i , j}^{M} P ( {s}_{ij} \vert {y}_{i} , G ) ∝ ( {\prod }_{i = 1}^{N} K ( {y}_{i} \vert {μ}_{y}^{′} , {σ}_{y}^{2} I ) ) \times ( {\prod }_{i , j}^{M} K ( {s}_{ij} \vert {μ}_{s}^{′} , {σ}_{s}^{2} I ) ) ∝ ( {\prod }_{i = 1}^{N} exp \{ - \frac{1}{2 {σ}_{y}^{2}} {( β {θ}_{h}^{T} h + ( 1 - β ) {θ}_{q}^{T} q - {y}_{i} )}^{2} \} ) \times ( {\prod }_{i , j}^{M} exp \{ - \frac{1}{2 {σ}_{s}^{2}} {( α {λ}_{g}^{T} g + ( 1 - α ) {λ}_{f}^{T} f - {s}_{ij} )}^{2} \} ) \qquad ( 23 )$$

In an example of the present disclosure, mutual bidirectional interactions and interdependencies between social actions and social ties are modeled, which are consistent with real world scenarios. In this way, mutual benefits between social actions and social ties can be sufficiently propagated to boost both performances. However, the WTSP model may also be applied to single prediction task.

In an example, a WTSP model may be provided for social action prediction. The task of social action prediction is to find the most likely types of social actions y* that have the MAP probability such that Formula (24) may be satisfied.

$${y}^{*} = {arg max}_{y} P ( y \vert G ) \qquad ( 24 )$$

Under the circumstance, the WTSP model can be defined as Formulas (25)-(26).

$$\begin{matrix}P ( y \vert G ) ∝ ( {\prod }_{i = 1}^{N} K ( {y}_{i} \vert {μ}_{y}^{′} , {σ}_{y}^{2} I ) ) ∝ {\prod }_{i = 1}^{N} exp \{ - \frac{1}{2 {σ}_{y}^{2}} {( β {θ}_{h}^{T} h + ( 1 - β ) {θ}_{q}^{T} q - {y}_{i} )}^{2} \} & ( 25 ) \\ {μ}_{y}^{′} = β {\sum }_{r ∈ WT ( {u}_{i} )} {θ}_{r} {h}_{r} ( {u}_{i} , {x}_{ij}^{′} ) + ( 1 - β ) {\sum }_{v ∈ ST ( {u}_{i} )} {θ}_{v} {q}_{v} ( {u}_{i} , {z}_{ij}^{′} ) & ( 26 )\end{matrix}$$

It can be seen from Formulas (24)-(26) that the model parameter vector for the deep learning process is W={θₕ,θ_{q}}. The sum-of-squared-errors objective function with quadratic regularization terms can be written as Formula (27).

$$L ( D , {θ}_{h} , {θ}_{q} ) = \frac{1}{2} {\prod }_{i = 1}^{N} {( β {θ}_{h}^{T} h + ( 1 - β ) {θ}_{q}^{T} q - {y}_{i} )}^{2} + \frac{{d}_{h}}{2} {‖ {θ}_{h} ‖}_{F}^{2} + \frac{{d}_{q}}{2} {‖ {θ}_{q} ‖}_{F}^{2} \qquad ( 27 )$$

Accordingly, for the deep learning procedure, Formulas (28) and (29) may be calculated, which are the same as Formulas (14) and (15), respectively.

$$\begin{matrix}\frac{\partial L}{\partial {θ}_{h}} = β {\prod }_{i = 1}^{N} ( β {θ}_{h}^{T} h + ( 1 - β ) {θ}_{q}^{T} q - {y}_{i} ) h + {d}_{h} {θ}_{h} & ( 28 ) \\ \frac{\partial L}{\partial {θ}_{q}} = ( 1 - β ) {\prod }_{i = 1}^{N} ( β {θ}_{h}^{T} h + ( 1 - β ) {θ}_{q}^{T} q - {y}_{i} ) q + {d}_{q} {θ}_{q} & ( 29 )\end{matrix}$$

In an example, a WTSP model may be provided for social tie inference. The task of social tie inference is to find the most likely labels of social ties s* that have the MAP probability such that Formula (30) may be satisfied.

$${s}^{*} = {arg max}_{s} P ( s \vert G ) \qquad ( 30 )$$

Under the circumstance, the WTSP model can be defined as Formulas (31)-(32).

$$\begin{matrix}P ( s \vert G ) ∝ {\prod }_{i , j}^{M} K ( {s}_{ij} \vert {μ}_{s} , {σ}_{s}^{2} I ) ∝ {\prod }_{i , j}^{M} exp \{ - \frac{1}{2 {σ}_{s}^{2}} {( {αλ}_{g}^{T} g + ( 1 - α ) {λ}_{f}^{T} f - {s}_{ij} )}^{2} \} & ( 31 ) \\ {μ}_{s} = α {\sum }_{k ∈ WT ( {u}_{i} , {u}_{j} )} {λ}_{k} {g}_{k} ( {u}_{i} , {u}_{j} , {x}_{ij} ) + ( 1 - α ) {\sum }_{l ∈ ST ( {u}_{i} , {u}_{j} )} {λ}_{l} {f}_{l} ( {u}_{i} , {u}_{j} , {z}_{ij} ) & ( 32 )\end{matrix}$$

It can be seen from Formulas (30)-(32) that the model parameter vector for the deep learning process is W={λ_{g},λ_{f}}. The sum-of-squared-errors objective function with quadratic regularization terms could be written as Formula (33).

$$L ( D , {λ}_{g} , {λ}_{f} ) = \frac{1}{2} {\prod }_{i , j}^{M} {( {αλ}_{g}^{T} g + ( 1 - α ) {λ}_{f}^{T} f - {s}_{ij} )}^{2} + \frac{{d}_{g}}{2} {‖ {λ}_{g} ‖}_{F}^{2} + \frac{{d}_{f}}{2} {‖ {θ}_{f} ‖}_{F}^{2} \qquad ( 33 )$$

Accordingly, for the deep learning procedure, Formulas (34) and (35) may be calculated, which are the same as Formulas (12) and (13), respectively.

$$\begin{matrix}\frac{\partial L}{\partial {λ}_{g}} = α {\prod }_{i , j}^{M} ( α {λ}_{g}^{T} g + ( 1 - α ) {λ}_{f}^{T} f - {s}_{ij} ) g + {d}_{g} {λ}_{g} & ( 34 ) \\ \frac{\partial L}{\partial {λ}_{f}} = ( 1 - α ) {\prod }_{i , j}^{M} ( α {λ}_{g}^{T} g + ( 1 - α ) {λ}_{f}^{T} f - {s}_{ij} ) f + {d}_{f} {λ}_{f} & ( 35 )\end{matrix}$$

In an example, the present disclosure provides a social network model for social prediction. In the social network model, weak ties and strong ties of a user are taken into consideration together. After the social network model is established, input data are given to train the social network model, in order to obtain model parameters. The procedure of obtaining the model parameters is a machine learning procedure. With the model parameters and the social network model, social data of a user not known yet may be predicted. An applicable scenario may be to predict whether a user is idle, active or busy, or to predict whether the social tie of two users is friend, family or acquaintance according to a method provided in FIGS. 1-13.

FIG. 5 is a flowchart illustrating a method 500 of performing social prediction according to an example of the present disclosure. Although execution of the method 500 is described below with reference to the device 100, the components for executing the method 500 may be spread among multiple devices/systems. The method 500 may be implemented in the form of executable instructions stored on a machine-readable storage medium, and/or in the form of electronic circuitry. In one example, the method 500 can be executed by at least one processor (e.g., processor 101) of a computing device (e.g., device 100). In other examples, the method may be executed by another processor in communication with the device 100.

At block 501, a processor may create a social network model, and apply a first model for weak ties and a second model for strong ties. In an example, the weak ties and the strong ties may be classified according to tie strength of connections of user pairs within the social network. At block 502, a processor may obtain input data of the social network, and train the social network model by use of the input data to obtain model parameters. At block 503, a processor may predict social data of a user by using the model parameters and the social network model. In the example, the social prediction method incorporates the strength of weak ties for social prediction tasks, in view of the situation that weak ties play important role in information diffusion.

In an example, the social network model may be a probability distribution of social prediction features selected from the group including social actions and social ties. The probability distribution may be calculated according to a probability density function. The mean of the probability density function is determined according to a weak tie influence result and a weighting factor for the weak ties, and also according to a strong tie influence result and a weighting factor for the strong ties.

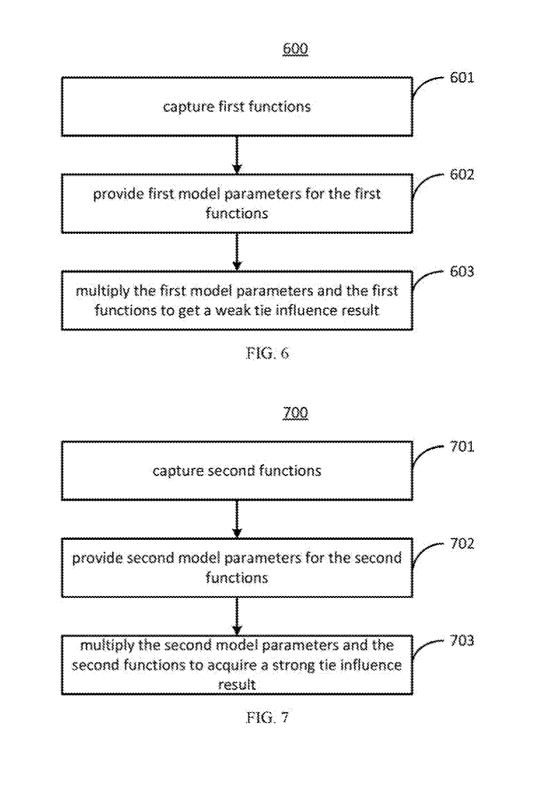

Specifically, a procedure of obtaining a weak tie influence result 600 is as shown in FIG. 6. At block 601, a processor may capture first functions, which are properties of the social prediction features related to the weak ties. At block 602, a processor may provide first model parameters for the first functions. At block 603, a processor may multiply the first model parameters and the first functions to get the weak tie influence result.

In an example, the social prediction features may be both the social actions and the social ties, and the weak tie influence result may be defined in Formula (36) and Formula (37), respectively. I₁ is the weak tie influence result for the social ties, and other notations in Formula (36) have the same meanings as those in Formula (4). I₂ is the weak tie influence result for the social actions, and other notations in Formula (37) have the same meanings as those in Formula (6).

$$\begin{matrix}{I}_{1} = {\sum }_{k ∈ WT ( {u}_{i} , {u}_{j} )} {λ}_{k} {g}_{k} ( {u}_{i} , {u}_{j} , {x}_{ij} ) & ( 36 ) \\ {I}_{2} = {\sum }_{r ∈ WT ( {u}_{i} )} {θ}_{h} {h}_{r} ( {u}_{i} , {m}_{ij} ) & ( 37 )\end{matrix}$$

In another example, the social prediction features may be the social actions, and the weak tie influence result I₃ may be defined in Formula (38), which can make reference to Formula (20). In another example, the social prediction features may be the social ties, and the weak tie influence result I₄ may be defined in Formula (39), which can make reference to Formula (32).

$$\begin{matrix}{I}_{3} = {\sum }_{r ∈ WT ( {u}_{i} )} {θ}_{r} {h}_{r} ( {u}_{i} , {x}_{ij}^{′} ) & ( 38 ) \\ {I}_{4} = {\sum }_{k ∈ WT ( {u}_{i} , {u}_{j} )} {λ}_{k} {g}_{k} ( {u}_{i} , {u}_{j} , {x}_{ij} ) & ( 39 )\end{matrix}$$

Specifically, a procedure of obtaining a strong tie influence result 700 is as shown in FIG. 7. At block 701, a processor may capture second functions, which are properties of the social prediction features related to the strong ties. At block 702, a processor may provide second model parameters for the second functions. At block 703, a processor may multiply the second model parameters and the second functions to acquire the strong tie influence result.

In an example, the social prediction features may be both the social actions and the social ties, and the strong tie influence result may be defined in Formula (40) and Formula (41), respectively. I₅ is the strong tie influence result for the social ties, and other notations in Formula (40) have the same meanings as those in Formula (4). I₆ is the strong tie influence result for the social actions, and other notations in Formula (41) may have the same meanings as those in Formula (6).

$$\begin{matrix}{I}_{5} = {\sum }_{l ∈ ST ( {u}_{i} , {u}_{j} )} {λ}_{l} {f}_{l} ( {u}_{i} , {u}_{j} , {z}_{ij} ) & ( 40 ) \\ {I}_{6} = {\sum }_{v ∈ ST ( {u}_{i} )} {θ}_{v} {q}_{v} ( {u}_{i} , {w}_{ij} ) & ( 41 )\end{matrix}$$

In another example, the social prediction features may be the social actions, and the strong tie influence result I₇ may be defined in Formula (42), which can make reference to Formula (20). In another example, the social prediction features may be the social ties, and the strong tie influence result I₈ may be defined in Formula (43), which can make reference to Formula (32).

$$\begin{matrix}{I}_{7} = {\sum }_{v ∈ ST ( {u}_{i} )} {θ}_{v} {q}_{v} ( {u}_{i} , {z}_{ij}^{′} ) & ( 42 ) \\ {I}_{8} = {\sum }_{l ∈ ST ( {u}_{i} , {u}_{j} )} {λ}_{l} {f}_{l} ( {u}_{i} , {u}_{j} , {z}_{ij} ) & ( 43 )\end{matrix}$$

In an example, a procedure of training a social network model to obtain model parameters 800 may be shown in FIG. 8. At block 801, a processor may apply a Lagrange method on a probability distribution to get model parameters on a first layer. At block 802, a processor may calculate social data of a first layer according to the model parameters on the first layer and input data of the social network. At block 803, a processor may calculate model parameters on an i-th layer according to social data of an (i−1)th layer. At block 804, a processor may calculate social data of an i-th layer according to the model parameters on the i-th layer and the social data of the (i−1)th layer. As to blocks 803 and 804, i=2, . . . , L, and L is a preset value for controlling number of layers for training. In an example, L may represent L hidden layers illustrated in FIG. 4. In an example, the procedure of training 800 may refer to such as Formulas (10) and (11).

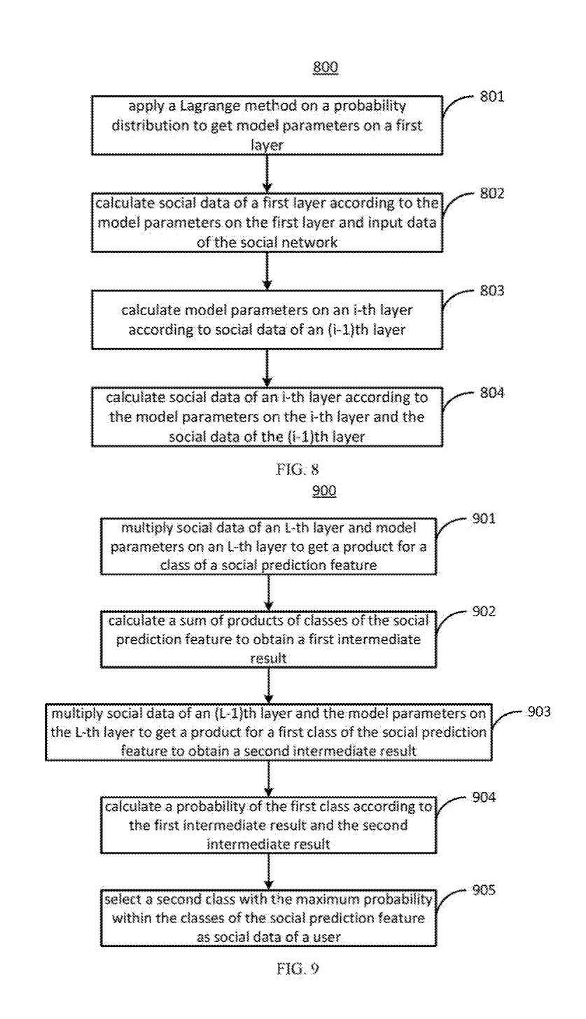

In an example, a procedure of predicting social data of a user 900 may be shown in FIG. 9. At block 901, a processor may multiply social data of an L-th layer and model parameters on the L-th layer to get a product for a class of a social prediction feature. At block 902, a processor may calculate a sum of products of classes of the social prediction feature to obtain a first intermediate result. At block 903, a processor may multiply social data of an (L−1)th layer and the model parameters on the L-th layer to get a product for a first class of the social prediction feature to obtain a second intermediate result. The first class is one of the classes of the social prediction feature. At block 904, a processor may calculate a probability of the first class according to the first intermediate result and the second intermediate result. At block 905, a processor may select a second class with the maximum probability within the classes of the social prediction feature as the social data of the user. Specifically, Formula (16) may be applied for the calculation of the probability of the first class.

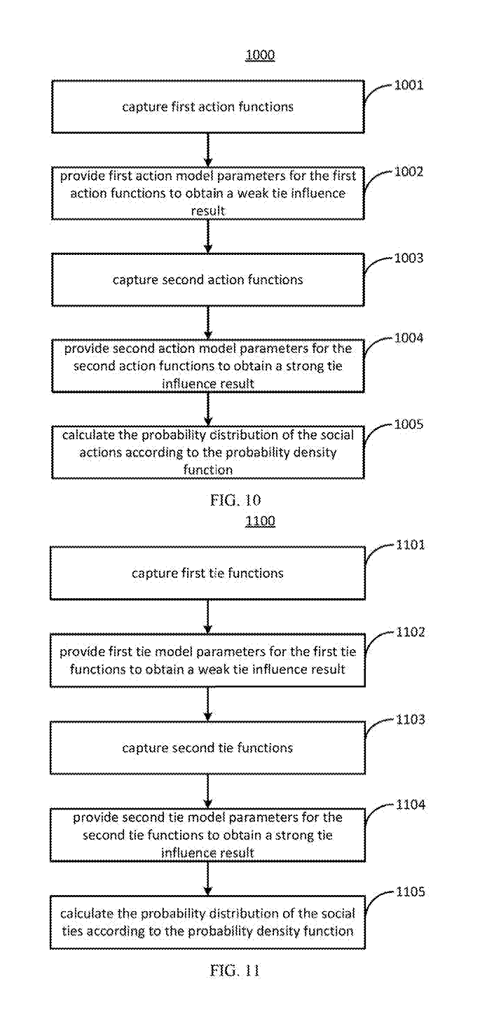

In an example, a procedure of setting a first model for weak ties and setting a second model for strong ties to generate a social network model 1000 may be shown in FIG. 10. At block 1001, a processor may capture first action functions, which are properties of social actions related to the weak ties. At block 1002, a processor may provide first action model parameters for the first action functions to obtain a weak tie influence result. At block 1003, a processor may capture second action functions, which are properties of social actions related to the strong ties. At block 1004, a processor may provide second action model parameters for the second action functions to obtain a strong tie influence result. At block 1005, a processor may calculate the probability distribution of the social actions according to the probability density function. A mean of the probability density function is determined according to the weak tie influence result and the weighting factor for the weak ties, and according to the strong tie influence result and the weighting factor for the strong ties. In the procedure 1000 of FIG. 10, Formulas (25)-(26) may be referred to.

In an example, a procedure of setting a first model for weak ties and setting a second model for strong ties to generate a social network model 1100 may be shown in FIG. 11. At block 1101, a processor may capture first tie functions, which are properties of social ties related to the weak ties. At block 1102, a processor may provide first tie model parameters for the first tie functions to obtain a weak tie influence result. At block 1103, a processor may capture second tie functions, which are properties of social ties related to the strong ties. At block 1104, a processor may provide second tie model parameters for the second tie functions to obtain a strong tie influence result. At block 1105, a processor may calculate the probability distribution of the social ties according to the probability density function. A mean of the probability density function is determined according to the weak tie influence result and the weighting factor for the weak ties, and according to the strong tie influence result and the weighting factor for the strong ties. In an example, Formulas (31)-(32) may be referred to in the procedure 1100 of FIG. 11.

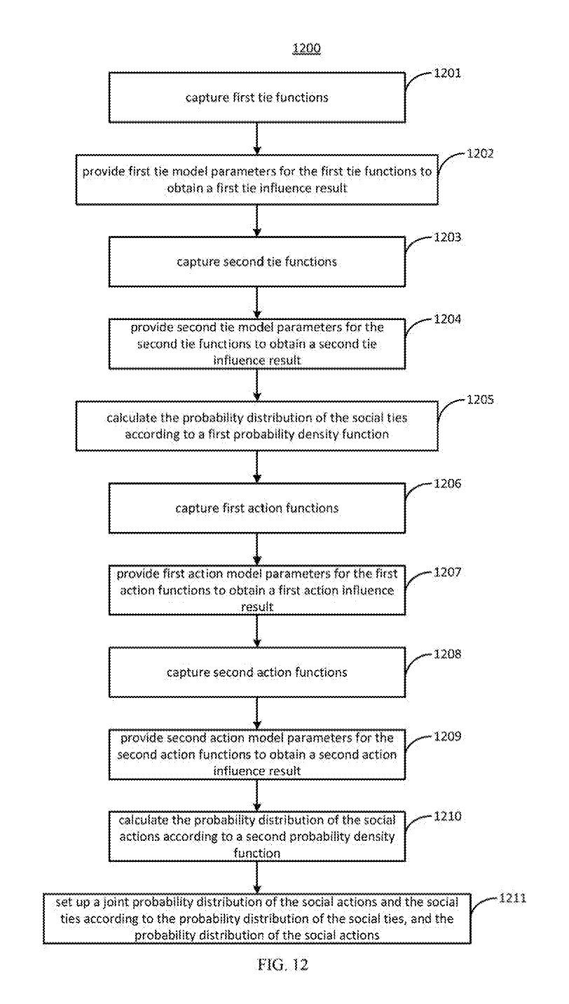

In an example, a procedure of setting a first model for weak ties and setting a second model for strong ties to generate a social network model 1200 may be shown in FIG. 12. At block 1201, a processor may capture first tie functions, which are properties of social ties related to the weak ties. At block 1202, a processor may provide first tie model parameters for the first tie functions to obtain a first tie influence result. At block 1203, a processor may capture second tie functions, which are properties of social ties related to the strong ties. At block 1204, a processor may provide second tie model parameters for the second tie functions to obtain a second tie influence result. At block 1205, a processor may calculate the probability distribution of the social ties according to a first probability density function. In an example, a mean of the first probability density function is determined according to the first tie influence result and a first tie factor, and according to the second tie influence result and a second tie factor. At block 1206, a processor may capture first action functions, which are properties of social actions related to the weak ties. At block 1207, a processor may provide first action model parameters for the first action functions to obtain a first action influence result. At block 1208, a processor may capture second action functions, which are properties of social actions related to the strong ties. At block 1209, a processor may provide second action model parameters for the second action functions to obtain a second action influence result. At block 1210, a processor may calculate the probability distribution of the social actions according to a second probability density function. In an example, a mean of the second probability density function is determined according to the first action influence result and a first action factor, and according to the second action influence result and a second action factor. At block 1211, a processor may set up a joint probability distribution of the social actions and the social ties according to the probability distribution of the social ties, and the probability distribution of the social actions. In an example. Formulas (3)-(7) and (18)-(22) may be referred to in the procedure 1100 of FIG. 12.

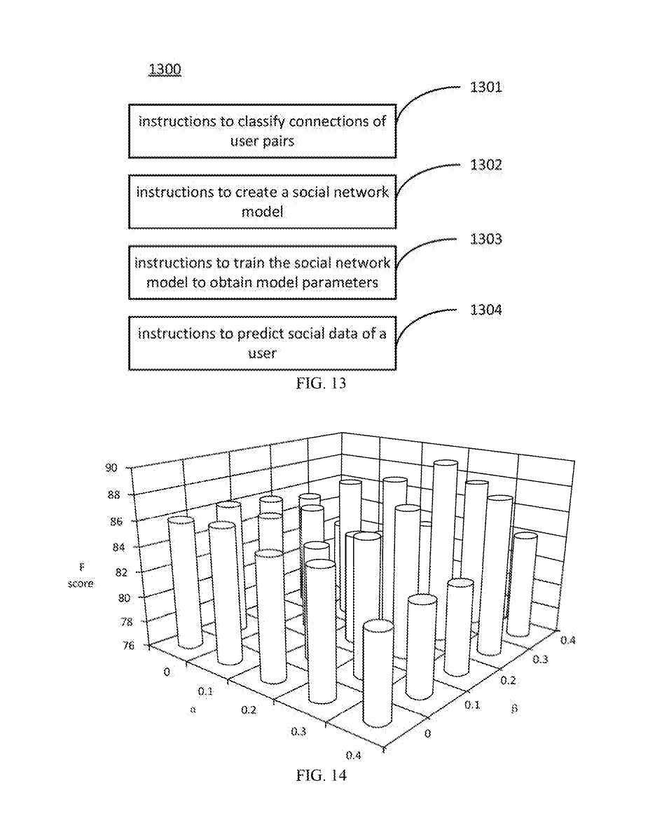

In an example, the above procedures illustrated in FIGS. 5-12 may be implemented via instructions stored in the memory 101 of the device 100 as illustrated in FIG. 1, or instructions stored in a non-volatile or non-transitory computer readable medium such as a magnetic or optical disk. FIG. 13 illustrates a non-transitory computer readable medium 1300 storing instructions executable by a processor. The computer readable medium 1300 may include instructions to classify connections of user pairs within the social network into weak ties and strong ties according to tie strength of the connections 1301; instructions to create a social network model 1302, wherein the social network model includes a first model for the weak ties and a second model for the strong ties; instructions to train the social network model to obtain model parameters 1303; and instructions to predict social data of a user by using the model parameters and the social network model 1304.

To evidence that the WTSP model provided in examples of the present disclosure works well, extensive experiments are performed. In an example, the experimental investigation is based on a mobile communication network. The mobile communication network may be used as a platform for social prediction to analyze and understand dynamics and characteristics in modern social networks. The mobile communication network has a mobile dataset including 3,268 mobile phone users, 30,776 social actions, and 18,489 social ties in total, respectively. The social actions are formed by calling or sending short messages between each other during a few months. The social ties are relationships including friend, family, and colleague. In the mobile dataset, the average number of weak ties, the maximal number of weak ties, the average number of strong ties, and the maximal number of strong ties are 22.67, 167, 62.45, and 269, respectively.

For quantitative performance evaluation, standard measures including area under the curve (AUC), root-mean-square error (RMSE), and F-measure are used. The WTSP model provided in an example is compared with several other methods for predicting social actions and discovering social ties. The other methods as references may include Support Vector Machine (SVM), Logistic Regression (LR), and Dynamic Conditional Random Fields (DCRF). It should be noted that the three models SVM, LR, and DCRF heavily rely on homophily to express the power of strong ties for social prediction without capturing the strength of weak ties.

Table 1 shows the performance on social action prediction, and Table 2 shows the performance on social tie inference of different models, respectively. It can be seen that the WTSP model achieves better performance on the three evaluation metrics than other comparison methods, illustrating the merits of the WTSP model for social prediction. One of the merits of the WTSP model may be to incorporate both weak and strong ties for social prediction. The experiment results of the WTSP model prove that ubiquitous weak ties in social networks are essentially important in promoting new ideas and novel perspectives across the dense clusters characterized by strong ties. Further, modeling bidirectional interactions between social actions and social ties may also increase the value of the WTSP model provided in examples of the present disclosure.

TABLE 1
Social action prediction performance on the mobile dataset

| Models | α | β | AUC | RMSE | F score |
|---|---|---|---|---|---|
| SVM | | | 0.785 | 0.494 | 79.85 |
| LR | | | 0.800 | 0.491 | 80.28 |
| DCRF | | | 0.833 | 0.459 | 85.37 |
| WTSP | α = 0 | β = 0 | 0.848 | 0.451 | 86.06 |
| | α = 0 | β = 0.1 | 0.850 | 0.447 | 86.42 |
| | α = 0.3 | β = 0.3 | 0.911 | 0.425 | 89.98 |
| | α = 1 | β = 1 | 0.572 | 1.127 | 42.39 |

TABLE 2
Social tie inference performance on the mobile dataset

| Models | α | β | AUC | RMSE | F score |
|---|---|---|---|---|---|
| SVM | | | 0.780 | 0.502 | 78.67 |
| LR | | | 0.783 | 0.495 | 79.52 |
| DCRF | | | 0.82 | 0.470 | 83.82 |
| WTSP | α = 0 | β = 0 | 0.830 | 0.463 | 84.63 |
| | α = 0 | β = 0.1 | 0.832 | 0.462 | 84.97 |
| | α = 0.3 | β = 0.3 | 0.872 | 0.428 | 88.56 |
| | α = 1 | β = 1 | 0.563 | 1.144 | 40.28 |

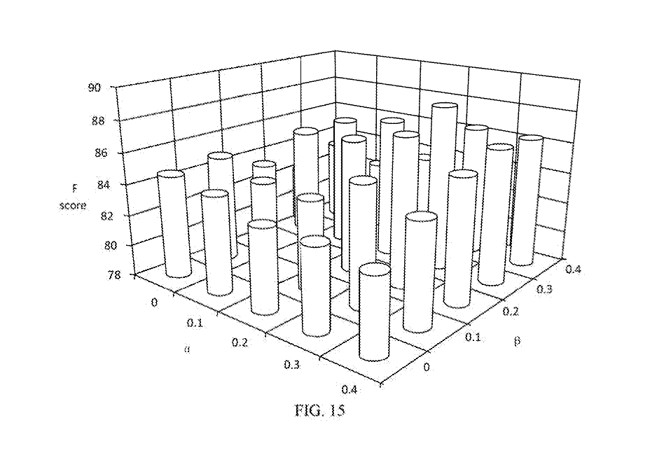

Moreover, the impact of weak ties of the WTSP model is examined, and 3D diagrams are drawn to illustrate contributions of the weak ties on social prediction F-measure performance on a mobile dataset. Specifically, FIG. 14 illustrates the impact of the weak ties on predicting social actions, and FIG. 15 illustrates the impact of the weak ties on labeling social ties. These two figures depict surprisingly interesting results. Exploiting the power of weak ties can lead to enhanced performance. For example, the best performance for the mobile dataset is obtained when α=0.3 and β=0.3 for both social action prediction and social tie labeling. These results demonstrate that the power of weak ties is very impressive. Consider that a user has 5 strong tie friends and 50 weak tie acquaintances, and suppose strong tie friends have high probability (e.g., 0.5) to influence the user's social action and weak tie acquaintances have low probability (e.g., 0.1) to affect the user's social action. Accordingly, the overall influence on the user's social action from the strong ties and the weak ties may be 5×0.5=2.5 and 50×0.1=5, respectively. Eventually, the weak ties may have more influence than the strong ties on the user's social action. That is, the power of weak ties in social prediction lies not in their individual effects but in their numbers for an overall collective effect. When weak ties occur in sufficient number, they have important impact on social prediction. That is, weak ties may play a significant role in social prediction and they can remarkably enhance the prediction accuracy for some networks. For such social networks, emphasize the contributions of weak ties can remarkably enhance the prediction performance. Also, FIGS. 14 and 15 show that strong ties are generally important contributors for social prediction. Both weak ties' contributions and contributions of strong ties may be considered to get end-to-end prediction performance. Neither of the weak ties and the strong ties can be completely ignored.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the present disclosure and its practical applications, to thereby enable others skilled in the art to best utilize the present disclosure and various examples with various modifications as are suited to the particular use contemplated.

What is claimed is:

1. A device of performing social prediction in a social network, comprising:
a processor;
a memory; and
instructions stored in the memory and executable by the processor, comprising:
instructions to classify connections of user pairs within the social network into weak ties and strong ties according to tie strength of the connections;
instructions to set a first model for the weak ties and set a second model for the strong ties to generate a social network model;
instructions to train the social network model to obtain model parameters, and
instructions to predict social data of a user by using the model parameters and the social network model.

2. The device according to claim 1, wherein the instructions to classify the connections of the user pairs comprise:
instructions to set a threshold for classifying the tie strength of the connections;
instructions to determine a connection as a weak tie when the tie strength of the connection is under the threshold; and
instructions to determine the connection as a strong tie when the tie strength of the connection is above the threshold.

3. The device according to claim 1, wherein the instructions to set the first model for the weak ties and set the second model for the strong ties to generate the social network model comprise:
instructions to set up a probability distribution of social prediction features, wherein the social prediction features are selected from the group comprising social actions and social ties;
instructions to set up first functions, and provide first model parameters for the first functions to obtain a weak tie influence result, wherein the first functions are properties of the social prediction features related to the weak ties;
instructions to set up second functions, and provide second model parameters for the second functions to obtain a strong tie influence result, wherein the second functions are properties of the social prediction features related to the strong ties;
instructions to calculate the probability distribution according to a probability density function, wherein a mean of the probability density function is determined according to the weak tie influence result and a weighting factor for the weak ties, and according to the strong tie influence result and a weighting factor for the strong ties.

4. The device according to claim 3, wherein the instructions to train the social network model to obtain the model parameters comprise:
instructions to apply a Lagrange method on the probability distribution to get model parameters on a first layer;
instructions to calculate social data of a first layer according to the model parameters on the first layer and input data of the social network; and
instructions to calculate model parameters on an i-th layer according to social data of an (i−1)th layer, and calculate social data of an i-th layer according to the model parameters on the i-th layer and the social data of the (i−1)th layer, wherein i=2, . . . , L, and L is a preset value.

5. The device according to claim 4, wherein the instructions to predict the social data of the user comprise:
instructions to multiply model parameters on an L-th layer and social data of an L-th layer to get a product for a class of the social prediction feature, and calculate a sum of products of classes of the social prediction feature to obtain a first intermediate result;
instructions to multiply the model parameters on the L-th layer and social data of an (L−1)th layer to get a product for a first class of the social prediction feature, to obtain a second intermediate result, wherein the first class is one of the classes of the social prediction feature;
instructions to calculate a probability of the first class according to the first intermediate result and the second intermediate result; and
instructions to select a second class with the maximum probability within the classes of the social prediction feature as the social data of the user.

6. The device according to claim 3, wherein the instructions to set the first model for the weak ties and set the second model for the strong ties to generate the social network model comprise:
instructions to capture first action functions, wherein the first action functions are properties of the social actions related to the weak ties, and provide first action model parameters for the first action functions to obtain the weak tie influence result;
instructions to capture second action functions, wherein the second action functions are properties of the social actions related to the strong ties, and provide second action model parameters for the second action functions to obtain the strong tie influence result; and
instructions to calculate the probability distribution of the social actions according to the probability density function, wherein the mean of the probability density function is determined according to the weak tie influence result and the weighting factor for the weak ties, and according to the strong tie influence result and the weighting factor for the strong ties.

7. The device according to claim 3, wherein the instructions to set the first model for the weak ties and set the second model for the strong ties to generate the social network model comprise:
instructions to capture first tie functions, wherein the first tie functions are properties of the social ties related to the weak ties, and provide first tie model parameters for the first tie functions to obtain the weak tie influence result;
instructions to capture second tie functions, wherein the second tie functions are properties of the social ties related to the strong ties, and provide second tie model parameters for the second tie functions to obtain the strong tie influence result; and
instructions to calculate the probability distribution of the social ties according to the probability density function, wherein the mean of the probability density function is determined according to the weak tie influence result and the weighting factor for the weak ties, and according to the strong tie influence result and the weighting factor for the strong ties.

8. The device according to claim 3, wherein the instructions to set the first model for the weak ties and set the second model for the strong ties to generate the social network model comprise:
instructions to capture first tie functions, wherein the first tie functions are properties of the social ties related to the weak ties, and provide first tie model parameters for the first tie functions to obtain a first tie influence result;
instructions to capture second tie functions, wherein the second tie functions are properties of the social ties related to the strong ties, and provide second tie model parameters for the second tie functions to obtain a second tie influence result;
instructions to calculate the probability distribution of the social ties according to a first probability density function, wherein a mean of the first probability density function is determined according to the first tie influence result and a first tie factor, and according to the second tie influence result and a second tie factor;
instructions to capture first action functions, wherein the first action functions are properties of the social actions related to the weak ties, and provide first action model parameters for the first action functions to obtain a first action influence result;
instructions to capture second action functions, wherein the second action functions are properties of the social actions related to the strong ties, and provide second action model parameters for the second action functions to obtain a second action influence result;
instructions to calculate the probability distribution of the social actions according to a second probability density function, wherein a mean of the second probability density function is determined according to the first action influence result and a first action factor, and according to the second action influence result and a second action factor; and
instructions to set up a joint probability distribution of the social actions and the social ties according to the probability distribution of the social ties, and the probability distribution of the social actions.

9. A method of performing social prediction in a social network, comprising:
creating a social network model, and applying a first model for weak ties and a second model for strong ties in the social network model, wherein the weak ties and the strong ties are classified according to tie strength of connections of user pairs within the social network;
obtaining input data of the social network, and training the social network model by use of the input data to obtain model parameters; and
predicting social data of a user by using the model parameters and the social network model.

10. The method according to claim 9, wherein creating the social network model, and applying the first model for the weak ties and the second model for the strong ties comprises:
setting up a probability distribution of social prediction features, wherein the social prediction features are selected from the group comprising social actions and social ties; and
capturing first functions, wherein the first functions are properties of the social prediction features related to the weak ties, and providing first model parameters for the first functions to obtain a weak tie influence result;
capturing second functions, wherein the second functions are properties of the social prediction features related to the strong ties, and providing second model parameters for the second functions to obtain a strong tie influence result; and
calculating the probability distribution according to a probability density function, wherein a mean of the probability density function is determined according to the weak tie influence result and a weighting factor for the weak ties, and according to the strong tie influence result and a weighting factor for the strong ties.

11. The method according to claim 10, wherein training the social network model by use of the input data to obtain the model parameters comprises:
applying a Lagrange method on the probability distribution to get model parameters on a first layer;
calculating social data of a first layer according to the model parameters on the first layer and the input data; and
calculating model parameters on an i-th layer according to social data of an (i−1)th layer, and calculate social data of an i-th layer according to the model parameters on the i-th layer and the social data of the (i−1)th layer, wherein i=2, . . . , L, and L is a preset value.

12. The method according to claim 10, wherein predicting the social data of the user comprises:
multiplying model parameters on an L-th layer and social data of an L-th layer to get a produce for a class of the social prediction feature, and calculating a sum of products of classes of the social prediction feature to obtain a first intermediate result;
multiplying the model parameters on the L-th layer and social data of an (L−1)th layer to get a product for a first class of the social prediction feature, to obtain a second intermediate result, wherein the first class is one of the classes of the social prediction feature;
calculating a probability of the first class according to the first intermediate result and the second intermediate result; and
selecting a second class with the maximum probability within the classes of the social prediction feature as the social data of the user.

13. A non-transitory computer readable medium storing instructions executable by a processor, wherein the instructions are to cause the processor to:
classify connections of user pairs within the social network into weak ties and strong ties according to tie strength of the connections;
create a social network model, wherein the social network model includes a first model for the weak ties and a second model for the strong ties;
train the social network model to obtain model parameters; and
predict social data of a user by using the model parameters and the social network model.

14. The non-transitory computer readable medium according to claim 13, wherein the instructions are to cause the processor to:
set up a probability distribution of social prediction features, wherein the social prediction features are selected from the group comprising social actions and social ties; and
set up first functions, wherein the first functions are properties of the social prediction features related to the weak ties, and provide first model parameters for the first functions to obtain a weak tie influence result;
set up second functions, wherein the second functions are properties of the social prediction features related to the strong ties, and provide second model parameters for the second functions to obtain a strong tie influence result; and
calculate the probability distribution according to a probability density function, wherein a mean of the probability density function is determined according to the weak tie influence result and a weighting factor for the weak ties, and according to the strong tie influence result and a weighting factor for the strong ties.

15. The non-transitory computer readable medium according to claim 14, wherein the instructions are to cause the processor to:
apply a Lagrange method on the probability distribution to get model parameters on a first layer;
calculate social data of a first layer according to the model parameters on the first layer and input data of the social network; and
calculate model parameters on an i-th layer according to social data of an (i−1)th layer, and calculate social data of an i-th layer according to the model parameters on the i-th layer and the social data of the (i−1)th layer, wherein i=2, . . . , L, and L is a preset value.
